(19) United States
(12) Patent Application Publication
(10) Pub. No.: US 2025/0383477 A1
(43) Pub. Date: Dec. 18, 2025

(54) DRIVING-SPECIFIC EYEWEAR

(71) Applicant: Zenni Optical, Inc., Novato, CA (US)

(72) Inventors: Feng LIU, Zhenjiang (CN); Xule CHEN, Zhenjiang (CN); Liangliang MAO, Zhenjiang (CN); Yu Julia ZHEN, Novato, CA (US); ChyrSong TING, Novato, CA (US); Steven LEE, Barrington, IL (US)

(21) Appl. No.: 19/236,983

(22) Filed: Jun. 13, 2025

Related U.S. Application Data
(60) Provisional application No. 63/659,797, filed on Jun. 13, 2024.

(51) Int. Cl. G02B 1/115; G02B 1/04; G02B 1/14; G02B 1/18; G02C 7/10

(52) U.S. Cl. CPC G02B 1/115; G02B 1/041; G02B 1/18; G02C 7/108; G02B 1/14

(57) ABSTRACT

Eyeglasses can protect wearers from discomfort and inconvenience caused by fogged-up eyeglass lenses or blue light and glare induced vision fatigue. Some aspects of the present disclosure relate to an eyeglass lens with a resin lens, a hardened layer, an anti-reflection coating, and an optional anti-fog coating. The anti-reflection coating and the anti-fog coating can be vacuum coated onto the resin lens and the hardened layer by an electron gun. This layered structure makes the eyeglass lens resistant to condensation. Some aspects of the present disclosure relate to an eyeglass lens with a resin lens, a hard coating, an anti-reflection coating, and an ultra-hydrophobic layer. The hard coating can be dip coated onto the resin lens, and the anti-reflection coating can be vacuum coated onto the hard coating. This layered structure reflects blue light to limit the amount of vision fatigue experienced by the wearer.

### CROSS-REFERENCE TO RELATED APPLICATIONS

This application claims priority to and the benefit of U.S. Ser. No. 63/659,797, filed Jun. 13, 2024, each of which is hereby incorporated by reference in its entirety.

### BACKGROUND

### Field of the Inventions

The present disclosure relates to eyeglass lenses. More specifically, the present disclosure relates to eyeglass lenses having coatings that are resistant to condensation and/or that can reduce vision fatigue caused by blue light exposure.

### Description of the Related Art

The use of eyeglasses that are tailored to the specific lighting and environmental conditions is increasingly prevalent in different aspects of everyday life. However, making eyeglasses that are compatible with other aspects of everyday life such as encountering temperature changes and driving can often be a challenge.

### SUMMARY

In accordance with at least some embodiments disclosed herein is the realization that eyeglass lenses often become fogged up and can block vision, usually due to condensation. Condensation can fog up eyeglass lenses when a wearer of the eyeglasses drinks hot coffee, cooks dinner, or even enters a warm room after being outside in the cold. For healthcare professionals, or even laypersons during a health crisis, eyeglasses can fog up when they are worn with medical masks. Fog on eyeglass lenses is inconvenient, and sometimes even dangerous (e.g., when the wearer is driving or performing surgery). To make matters worse, clearing up the fog is difficult. While the condensation will naturally evaporate eventually, that takes time, which makes this solution increasingly inconvenient as people adopt quicker-paced lifestyles. Wiping away the condensation also is not a good solution because wiping often results in streaking, which also makes it hard to see out of eyeglasses.

Conventional attempts at preventing eyeglasses from fogging up consist of an anti-fog spray and a cloth. Wearers can apply the anti-fog spray to their lenses and rub the anti-fog spray into the lenses with a cloth. However, in accordance with at least some embodiments disclosed herein is the realization that the anti-fog spray is only effective for approximately four to five days, which means this solution requires constant, cumbersome maintenance. Additionally, wearers must pay the cost of the anti-fog spray repeatedly, which becomes expensive over time. An alternative conventional solution to fogged up lenses are anti-fog lenses. However, existing anti-fog lenses generally cannot maintain the anti-fog effect over extended periods of use. Moreover, most of the existing anti-fog lenses have very low surface hardness, making them prone to damage when the eyeglasses are worn consistently.

The present disclosure addresses these and other challenges by providing innovative systems, methods, and devices that each have several innovative and beneficial aspects, no single one of which is solely responsible for the desirable attributes disclosed herein.

In accordance with at least some embodiments disclosed herein is the realization that the fogged-up lenses can be addressed by eyewear with a layered structure made up of a resin lens with an anti-reflection coating and an anti-fog coating thermal evaporated onto the resin lens.

In accordance with at least some embodiments disclosed herein is the realization that eyeglass lenses often fail to filter out glare and blue light.

For example, when a person is driving, they constantly encounter glare as the sun reflects off other cars on the road, off snow on the ground, or off a wet road after a rainy day—to name a few. Over long periods of driving, encountering glare can result in vision fatigue. A similar vision fatigue can result from exposure to blue light. Blue light is a type of light with a very high energy-especially in the wavelength range of 400 nm to 455 nm, the high intensity of which can cause visual fatigue. People are commonly exposed to blue light from headlights on automotive vehicles, smart phone screens, laptop screens, and television screens, among others. In a driving setting, strong and sudden flashes of blue light from the headlights of other vehicles on the road can cause transient blindness, which is dangerous when operating a moving vehicle.

Additionally, in a society that is increasingly reliant on smart phone screens and laptop screens, people are constantly exposed to blue light in both recreational and workplace settings. For most people in society, it is almost impossible to avoid driving or using a smart phone or laptop screen. Therefore, people need protection from constant blue light exposure in order to limit vision fatigue.

Conventional attempts at eyeglass lenses that reflect blue light do not reflect enough blue light to meaningfully limit vision fatigue. Similarly, some existing blue-light-reflecting lenses reflect visible light that is useful, which impairs vision. Additionally, conventional blue-light-reflecting lenses have low surface hardness, which makes the lenses prone to damage over extended periods of use.

The systems, methods, and devices of this disclosure each have several innovative aspects, no single one of which is solely responsible for the desirable attributes disclosed herein.

In accordance with at least some embodiments disclosed herein is the realization that vision fatigue caused by glare and blue light can be addressed by eyewear with a layered structure made up of a resin lens with a dip-coated hardened coating and a thermal evaporated anti-reflection coating.

Additional features and advantages of the subject technology will be set forth in the description below, and in part will be apparent from the description, or may be learned by practice of the subject technology. The advantages of the subject technology will be realized and attained by the structure particularly pointed out in the written description and embodiments hereof as well as the appended drawings.

It is to be understood that both the foregoing general description and the following detailed description are exemplary and explanatory and are intended to provide further explanation of the subject technology.

### BRIEF DESCRIPTION OF THE FIGURES

Various features of illustrative embodiments of the inventions are described below with reference to the drawings. The illustrated embodiments are intended to illustrate, but not to limit, the inventions. The drawings contain the following figures:

FIG. 1 illustrates a cross-sectional view of a first embodiment of the layered structure of an eyeglass lens that is resistant to condensation, according to some embodiments of the present disclosure.

FIG. 2 illustrates an exploded view of the layers that constitute a second embodiment of the layered structure of an eyeglass lens that is resistant to condensation, according to some embodiments of the present disclosure.

FIG. 3 illustrates an exploded view of the layers that constitute the layered structure of a blue-light-reflecting eyeglass lens, according to some embodiments of the present disclosure.

FIG. 4 illustrates a top view of a resin lens of the blue-light-reflecting eyeglass lens, according to some embodiments of the present disclosure.

FIG. 5 illustrates the spectrum of radiation that is transmitted by a first embodiment of the blue-light-reflecting eyeglass lens, according to some embodiments of the present disclosure.

FIG. 6 illustrates the spectrum of radiation that is transmitted by a first comparison example of the blue-light-reflecting eyeglass lens, according to some embodiments of the present disclosure.

### DETAILED DESCRIPTION

It is understood that various configurations of the subject technology will become readily apparent to those skilled in the art from the disclosure, wherein various configurations of the subject technology are shown and described by way of illustration. As will be realized, the subject technology is capable of other and different configurations and its several details are capable of modification in various other respects, all without departing from the scope of the subject technology. Accordingly, the summary, drawings and detailed description are to be regarded as illustrative in nature and not as restrictive.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

The present disclosure provides for an anti-fog eyeglass lens. The anti-fog eyeglass lens is configured to resist the formation of condensation on the eyeglass lens. Existing eyeglasses and anti-fog solutions are not designed to prevent fogging for extended periods of use.

In accordance with at least some embodiments disclosed herein is the realization that condensation that gathers on eyeglasses is inconvenient because it forms a fog that obscures the wearer's vision. Moreover, to remove the layer of fog formed on the eyeglasses, the wearer must wipe the glasses, which often results in streak marks that can also obscure the wearer's vision.

The eyeglass lenses described herein are designed to be resistant to condensation, which means that a layer of fog will not form on the eyeglass lenses. The eyeglass lenses include a layered structure that is designed to reduce the surface tension of beads of condensation. With reduced surface tension, the beads of condensation can aggregate to form an ultra-thin water film on the eyeglass lenses instead of a layer of fog. The uniform, ultra-thin water film can be preferable to the layer of fog because the numerous individual droplets that make up the layer of fog can scatter light rays in a manner that significantly obscures vision. On the other hand, the ultra-thin water film can create a continuous layer that allows light to pass through with minimal distortion, which can allow clearer vision through the lens.

The eyeglass lens is a vacuum-coated resin lens with a layered structure. The layered structure includes a hardened layer disposed on one or both sides of the resin lens, an anti-reflection coating that is vacuum coated onto one or both sides of the hardened layer, and an anti-fog layer that is vacuum coated onto one or both sides of the anti-reflection coating.

The anti-fog eyeglass lens disclosed herein can be washed repeatedly and maintain its anti-fog effects. This design also evades the need for anti-fog spray, which reduces cost and environmental pollution. Moreover, this design allows for a surface hardness of up to 7 H, which indicates a very hard surface that is resistant to scratching. Thus, such a high surface hardness minimizes the impact of scratches on the surface of the lens, which can increase the longevity of the lens and maintain clear vision through the lenses. Finally, compared to conventional anti-fog lenses, which only transmit up to 89% of visible light, the anti-fog lenses according to the present disclosure can transmit up to 98% of visible light.

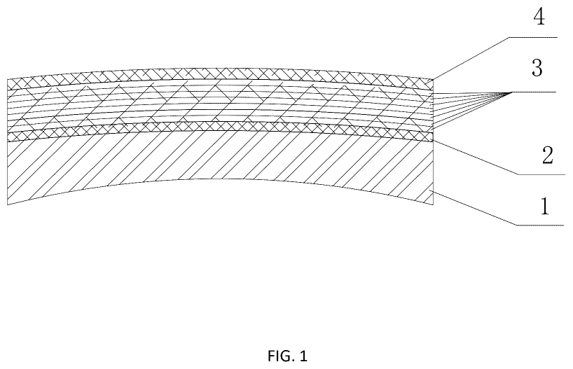

FIG. 1 illustrates a cross-sectional view of a first embodiment of the layered structure of an eyeglass lens that is resistant to condensation, according to some embodiments of the present disclosure. The layered structure includes a resin lens 1, a hardened layer 2, an anti-reflection coating 3, and an anti-fog layer 4. In some embodiments, the hardened layer 2, the anti-reflection coating 3, and the anti-fog layer 4 are applied to both sides of the resin lens 1. In this first embodiment, the hardened layer 2, the anti-reflection coating 3, and the anti-fog layer 4 are only applied to one side of the resin lens 1.

The resin lens is a flat structure with two opposite sides (i.e., a front side and a back side). The two opposite sides are referred to as the first surface and the second surface.

In some embodiments, the resin lens is a hardened resin lens. The first surface is activated by ion bombardment. Ion bombardment applies a denser film layer on the first surface of the resin lens, which creates the hardened layer. Optionally, the second surface is also activated by ion bombardment to create a second hardened layer.

Optionally, the hardened layer is a wear-resistant hardened layer. The hardened layer is wear-resistant in that it is more durable, which means that the eyeglass lens will resist condensation for a longer period of use.

Optionally, the wear-resistant hardened layer is dip coated on the first and/or second surfaces of the resin lens.

Optionally, the hardened layer is evenly distributed on the first and/or second surfaces of the resin lens.

An anti-reflection coating is disposed on each hardened layer. The anti-reflection coating is formed by vacuum coating the resin lens and the hardened layer. Optionally, the anti-reflection coating is an anti-reflection film.

The anti-reflection coating has a layered structure that includes a first SiO₂ layer, a first ZrO₂ layer, a second SiO₂ layer, a second ZrO₂ layer, a first ITO layer, a first Al₂O₃ layer, and a third SiO₂ layer. The layered structure is arranged with the first SiO₂ layer being nearest the resin lens and the third SiO₂ layer being farthest away from the resin lens.

The thickness of the layers in the layered structure varies throughout the structure. The first SiO₂ layer is between 105 nanometers (nm) and 130 nm thick. The first ZrO₂ layer is between 20 nm and 35 nm thick. The second SiO₂ layer is between 15 nm and 25 nm thick. The second ZrO₂ layer is between 40 nm and 55 nm thick. The first ITO layer is between 1 nm and 15 nm thick. The first Al₂O₃ layer is between 1 nm and 15 nm thick. Finally, the third SiO₂ layer is between 50 nm and 70 nm thick.

Optionally, the first SiO₂ layer is 115 nm thick, the first ZrO₂ layer is 25 nm thick, the second SiO₂ layer is 20 nm thick, the second ZrO₂ layer is 45 nm thick, the first ITO layer is 8 nm thick, the first Al₂O₃ layer is 6 nm thick, and the third SiO₂ layer is 25 nm thick.

Optionally, the first SiO₂ layer is 118 nm thick, the first ZrO₂ layer is 25 nm thick, the second SiO₂ layer is 20 nm thick, the second ZrO₂ layer is 46 nm thick, the first ITO layer is 10 nm thick, the first Al₂O₃ layer is 6 nm thick, and the third SiO₂ layer is 55 nm thick.

Optionally, the first SiO₂ layer is 120 nm thick, the first ZrO₂ layer is 30 nm thick, the second SiO₂ layer is 20 nm thick, the second ZrO₂ layer is 50 nm thick, the first ITO layer is 6 nm thick, the first Al₂O₃ layer is 10 nm thick, and the third SiO₂ layer is 65 nm thick. Optionally, the anti-reflection coating also includes a layer of Ti3O5 that is 30 nm thick. In the alternative, a layer of Ti3O5 that is 30 nm thick is disposed on the anti-reflection coating.

Optionally, the first SiO₂ layer is 120 nm thick, the first ZrO₂ layer is 30 nm thick, the second SiO₂ layer is 20 nm thick, the second ZrO₂ layer is 50 nm thick, the first ITO layer is 6 nm thick, the first Al₂O₃ layer is 10 nm thick, and the third SiO₂ layer is 65 nm thick. Optionally, the anti-reflection coating also includes a layer of HT-100 that is 15 nm thick. In the alternative, a layer of HT-100 that is 15 nm thick is disposed on the anti-reflection coating.

An anti-fog layer can be activated by ion bombardment and disposed on each anti-reflection coating by vacuum coating. The anti-fog layer can resist the formation of condensation through a combination of chemical properties and physical structure.

For example, the anti-fog layer can be activated by ion bombardment, which can modify the surface properties of the lens to be more hydrophilic. A hydrophilic lens can encourage the spread of water molecules across the surface of the lens, which can encourage the formation of the ultra-thin water film and can discourage the formation of a layer of fog or condensation.

Optionally, the anti-fog layer comprises a silicone polymer film layer, which has hydrophilic properties that encourage the water droplets to form a thin film rather than a layer of fog or condensation. The silicone polymer film layer can be heated during vacuum coating, which can fine tune the hydrophilic properties of the silicone polymers for optimal anti-fogging performance.

Furthermore, the anti-fog layer is formed by vacuum coating the resin lens, the hardened layer, and the anti-reflection layer. In particular, the anti-fog layer is formed by thermal evaporation. With this coating process, extremely thin, uniform layers of material can be deposited onto the lens such that each layer adheres well to the layers beneath it. The application of thin, uniform layers can reduce vision obstruction as compared to traditional lenses.

The anti-fog layer has a thickness between 5 nm and 105 nm. Optionally, the anti-fog layer has a thickness between 8 nm and 102 nm. In some embodiments, the effectiveness of the anti-fog layer can be dependent on the anti-fog layer having a thickness that maximizes surface area without compromising transparency.

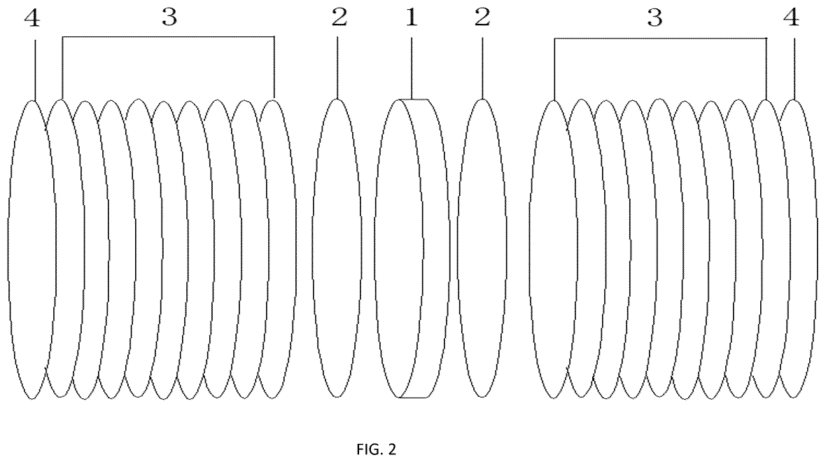

FIG. 2 illustrates an exploded view of the layers that constitute a second embodiment of the layered structure of an eyeglass lens that is resistant to condensation, according to some embodiments of the present disclosure. In this second embodiment, the hardened layer 2, the anti-reflection coating 3, and the anti-fog layer 4 are applied to both sides of the resin lens 1. As shown, the layers that constitute the layered structure are mirrored around the resin lens 1. The resin lens is adjacent to two hardened layers 2, each hardened layer 2 is adjacent to an anti-reflection coating 3, and each anti-reflection coating 3 is adjacent to an anti-fog layer 4.

The present disclosure also includes methods for manufacturing an eyeglass lens that is resistant to condensation. Such a method may include providing a resin lens as previously described with respect to FIGS. 1 and 2. The method may further include cleaning the resin lens with ultrasonic waves and drying the resin lens. The method may include cooling the resin lens to room temperature. A hardened layer may be applied to one or both sides of the resin lens. The method may also include placing the resin lens in a vacuum coating chamber and vacuum coating an anti-reflection coating and an anti-fog layer onto the lens. Vacuum coating the anti-reflection coating onto each of the hardened layers may include bombarding each of the hardened layers with Ar to activate each of the hardened layers and depositing on each of the hardened layers a layered structure of SiO₂, ZrO₂, ITO, and Al₂O₃, as described above with reference to FIGS. 1 and 2. Vacuum coating the anti-fog layer onto each of the anti-reflection coatings may include bombarding each of the anti-reflection coatings with Ar to activate each of the anti-reflection coatings and depositing the anti-fog layer on each of the anti-reflection coatings.

Optionally, cleaning the resin lens with ultrasonic waves and drying the resin lens may include placing the resin lens in an oven or heating chamber. Optionally, the oven has a temperature between 50° C. and 70° C. Optionally, the resin lens is placed on the oven for a time between 20 minutes and 40 minutes.

Optionally, depositing the anti-reflection and anti-fog coatings is done with an electron gun. Optionally, depositing the anti-reflection and anti-fog coatings is done by thermal evaporation.

Optionally, the method provides for curing the resin lens, the hardened layer, the anti-reflection coating, and the anti-fog layer at room temperature for approximately two hours.

The method for preparing vacuum-coated anti-fog lenses requires an electron gun power of about 10% to 50%, a thermal evaporation power of about 10% to 15%, an anode voltage of about 90 Volts (V) to 120 V, an anode current of about 1 Ampere (A) to 3 A, an O2 flow rate between about 0 cm3/min and 31 cm3/min (in other words, 0 standard cubic centimeters per minute (sccm) and 31 sccm), and an Ar flow rate of between about 0 cm3/min and 51 cm3/min. Moreover, the evaporation rates for vacuum coating the anti-reflection layer is between about 0.3 nm/s and 3 nm/s for SiO₂, about 0.1 nm/s to 2 nm/s for ZrO₂, and about 0.5 nm/s for Al₂O₃. Additionally, the evaporation rate for vacuum coating the anti-fog layer is about 0.12 nm/s.

In a first example, the first layer of SiO₂ has a thickness of 115 nm, the first layer of ZrO₂ has a thickness of 25 nm, the second layer of SiO₂ has a thickness of 20 nm, the second layer of ZrO₂ has a thickness of 45 nm, the first layer of ITO has a thickness of 8 nm, the first layer of Al₂O₃ has a thickness of 5 nm, and the third layer of SiO₂ has a thickness of 60 nm. The vacuum coating chamber has a vacuum pressure of 1.0×10-5 Pascals (Pa), an electron gun power of 10%, a thermal evaporation power of 15%, an anode voltage of 100 V, an anode current of 2 A, an O2 flow rate of 20 cm3/min, and an Ar flow rate of 30 cm3/min. For the thermal evaporation, the evaporation rate of SiO₂ is 0.8 nm/s, ZrO₂ is 1.0 nm/s, and Al₂O₃ is 0.5 nm/s. Furthermore, the special ion process layer has an evaporation rate of less than 1 nm/s, and the anti-fog layer has an evaporation rate of 0.1 nm/s. Finally, the anti-fog layer has a thickness of 25 nm.

In a second example, the first layer of SiO₂ has a thickness of 118 nm, the first layer of ZrO₂ has a thickness of 25 nm, the second layer of SiO₂ has a thickness of 20 nm, the second layer of ZrO₂ has a thickness of 46 nm, the first layer of ITO has a thickness of 10 nm, the first layer of Al₂O₃ has a thickness of 6 nm, and the third layer of SiO₂ has a thickness of 55 nm. The vacuum coating chamber has a vacuum pressure of 1.0×10-3 Pa, an electron gun power of 15%, a thermal evaporation power of 12%, an anode voltage of 120 V, an anode current of 3 A, an O2 flow rate of 10 cm3/min, and an Ar flow rate of 30 cm3/min. For the thermal evaporation, the evaporation rate of SiO₂ is 0.6 nm/s, ZrO₂ is 1.5 nm/s, and Al₂O₃ is 0.5 nm/s. Furthermore, the special ion process layer has an evaporation rate of 0.5 nm/s, and the anti-fog layer has an evaporation rate of 0.2 nm/s. Finally, the anti-fog layer has a thickness of 16 nm.

In a third example, the first layer of SiO₂ has a thickness of 120 nm, the first layer of ZrO₂ has a thickness of 30 nm, the second layer of SiO₂ has a thickness of 20 nm, the second layer of ZrO₂ has a thickness of 50 nm, the first layer of ITO has a thickness of 6 nm, the first layer of Al₂O₃ has a thickness of 10 nm, and the third layer of SiO₂ has a thickness of 30 nm. Additionally, there is a layer of Ti3O5 that is 30 nm thick on top of the third layer of SiO₂. The vacuum coating chamber has a vacuum pressure of 1.0×10-3 Pa, an electron gun power of 10%, a thermal evaporation power of 13%, an anode voltage of 90 V, an anode current of 3 A, an O2 flow rate of 30 cm3/min, and an Ar flow rate of 20 cm3/min. For the thermal evaporation, the evaporation rate of SiO₂ is 1.0 nm/s, ZrO₂ is 1.0 nm/s, and Al₂O₃ is 0.5 nm/s. Furthermore, the special ion process layer has an evaporation rate of 1.5 nm/s, and the anti-fog layer has an evaporation rate of 0.1 nm/s. Finally, the anti-fog layer has a thickness of 20 nm.

In a fourth example, the first layer of SiO₂ has a thickness of 120 nm, the first layer of ZrO₂ has a thickness of 30 nm, the second layer of SiO₂ has a thickness of 20 nm, the second layer of ZrO₂ has a thickness of 50 nm, the first layer of ITO has a thickness of 6 nm, the first layer of Al₂O₃ has a thickness of 10 nm, and the third layer of SiO₂ has a thickness of 65 nm. Additionally, there is a layer of HT-100 that is 15 nm thick on top of the third layer of SiO₂. The vacuum coating chamber has a vacuum pressure of 1.0×10-5 Pa, an electron gun power of 10%, an anode voltage of 90 V, an anode current of 3 A, an O₂ flow rate of 30 cm3/min, and an Ar flow rate of 20 cm3/min. For the thermal evaporation, the evaporation rate of SiO₂ is 1.0 nm/s, ZrO₂ is 1.0 nm/s, and Al₂O₃ is 0.5 nm/s. Furthermore, anti-fog layer has an evaporation rate of 0.1 nm/s. Finally, the anti-fog layer has a thickness of 20 nm.

The performance test results of each of these four examples as compared to a conventional anti-fog lens is provided in Table 1.

TABLE 1
Performance Test Results of a Conventional Anti-Fog Lens and Examples 1-4

| | Conventional | Example 1 | Example 2 | Example 3 | Example 4 |
|---|---|---|---|---|---|
| Water drop | ≤15° | 4° | 3° | 110° | 8° |
| angle | | | | | |
| Boiled | ≥95% | 100% | 100% | 100% | 90% |
| adhesion | | | | | |
| Transmittance | ≥90% | 96.51% | 96.73% | 95.67% | 89% |
| Anti-fog | 60° C. | Compliant | Compliant | Not | Compliant |
| performance | saturated | | | compliant | |
| | steam, 5 cm | | | | |
| | distance, no | | | | |
| | fogging for 3 | | | | |
| | minutes | | | | |
| Anti-fog | Soak in water | Compliant | Compliant | Not | Compliant |
| performance | for 1 hour, | | | compliant | |
| | anti-fog | | | | |
| | time > 8 s | | | | |
| Falling sand | Complies | Complies | Complies | Not | Complies |
| wear | with EN-166 | | | compliant | |
| resistance | standard | | | | |
| Surface | >2H | 7H | 7H | 7H | 7H |
| hardness | | | | | |

The present disclosure also provides for an anti-glare eyeglass lens (also referred to as a blue-light-reflecting eyeglass lens). The anti-glare eyeglass lens is configured to reflect blue light and limit the vision fatigue that results from blue light exposure. Existing eyeglasses that are designed for blue light protection often reflect more visible light than just the harmful blue light, which impairs the wearer's vision. Furthermore, existing eyeglasses for blue light protection have low surface hardness, which means that the eyeglasses lack durability and are likely to break in response to repeated use.

In accordance with at least some embodiments disclosed herein is the realization that people's eyes are constantly exposed to bright glare and harsh blue light, but eyeglasses do not properly reflect glare and blue light. Constant exposure to glare and blue light causes vision fatigue.

The eyeglass lenses described herein are designed to be anti-glare and blue-light-reflecting, which means that the eyeglass lenses will reflect harsh glare (e.g., from the headlights of other cars on the road) and blue light (e.g., from a cell phone screen). The eyeglasses include a layered structure that includes a resin lens, a hard coating on both sides of the resin lens, an anti-reflection coating on both sides of the hard coating, and an ultra-hydrophobic coating on both sides of the anti-reflection coating. The resin lens further includes a vision optimization area, which has vision correction and night vision enhancement.

The anti-glare lenses disclosed herein corrects vision and enhances night vision for safer driving. Additionally, the anti-glare lens has a surface hardness of approximately 7 H, which effectively limits the impact of surface scratches on the anti-glare lens. Finally, the anti-glare lens is ultra-hydrophobic (with a water drop angle of at least 115°, compared to an ordinary water drop angle of 107°), which effectively prevents fingerprints from forming on the lens and obstructing the wearer's field of vision.

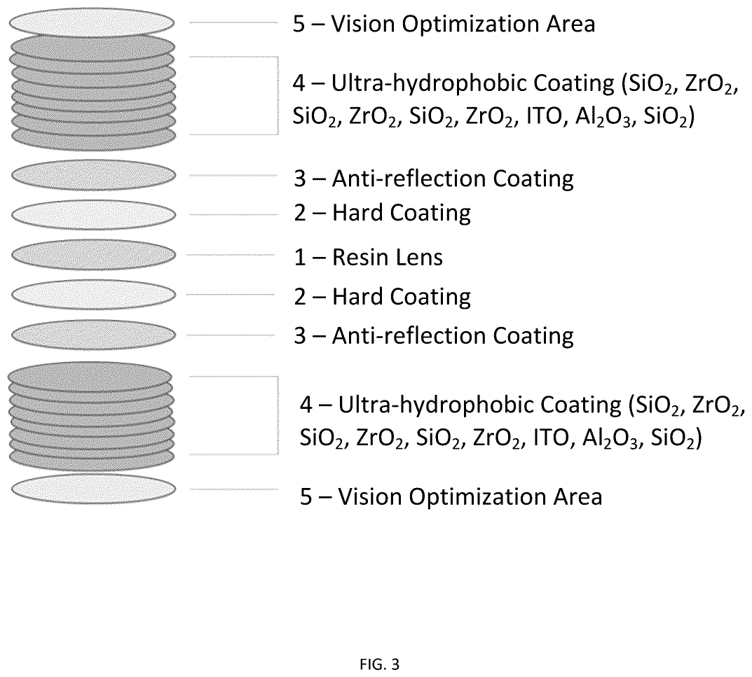

FIG. 3 illustrates an exploded view of the layers that constitute the layered structure of a blue-light-reflecting eyeglass lens, according to some embodiments of the present disclosure. The layered structure includes a resin lens 1, a hard coating 2, an anti-reflection coating 3, an ultra-hydrophobic coating 4, and a vision optimization area 5.

The resin lens is a flat structure with two opposite sides (i.e., a front side and a back side). The two opposite sides are referred to as the first surface and the second surface.

In some embodiments, the resin lens is a blue light blocking resin lens. Optionally, the blue light blocking resin lens has a refraction index between 1.20 and 2.00. Optionally, the blue light blocking resin lens has a refraction index between 1.49 and 1.74. Optionally, the blue light blocking resin lens has a refraction index of approximately 1.61.

Optionally, the hard coating is dip coated onto the first and second surfaces of the resin lens. Optionally, the hard coating is an organosilicon hard coating liquid.

In some embodiments, the hard coating can include a yellow light absorber. The yellow light absorber can enable the hard coating to absorb light at the wavelength of 585 nm. In other words, the yellow light absorber can reduce the amount of yellow light that passes through the lens and reaches the wearer's eyes. Yellow light, particularly at the 585 nm wavelength, is close to the wavelength of blue light, which has been associated with eye strain, particularly when using digital devices that emit a significant amount of blue light. Additionally, yellow light can contribute to glare and, in some circumstances (e.g., foggy or low-light settings), yellow light can be harsh on people's eyes. Filtering out yellow light at the 585 nm wavelength can reduce glare and improve visual contrast. In particular, for individuals who are sensitive to bright light or who need to discern contrast clearly (e.g., people who drive at night), filtering out yellow light can make the visual experience more comfortable and possibly improve reaction times. Moreover, some studies suggest that reflecting yellow light at the 585 nm wavelength can reduce the risk of macular generation and other forms of light-induced eye damage. Optionally, the hard coating is 0.001% to 0.1% 585 nm yellow light absorber. Optionally, the hard coating is about 0.008% yellow light absorber. Optionally, the hard coating is about 0.015% 585 nm yellow light absorber.

An anti-reflection coating is disposed on each hard coating. The anti-reflection coating can be vacuum coated onto the resin lens and the hard coating. Optionally, the anti-reflection coating is an anti-reflection film.

The anti-reflection coating has a layered structure that includes a first SiO₂ layer, a first ZrO₂ layer, a second SiO₂ layer, a second ZrO₂ layer, a third SiO₂ layer, a third ZrO₂ layer, a first ITO layer, a first Al₂O₃ layer, and a fourth SiO₂ layer. The layered structure is arranged with the first SiO₂ layer being nearest the resin lens in the fourth SiO₂ layer being farthest away from the resin lens. Each layer is carefully selected for its refractive index and applied at a specific thickness such that the layered structure interferes destructively with light rays in the blue portion of the visible light spectrum. By doing so, these layers can enhance the transmission of light through the lens and can reduce reflections that can cause glare. Moreover, the utilization of ITO and Al₂O₃ can maximize the transparency of the lens while also minimizing the reflectivity of the lens for optimal visual comfort and clarity.

The thickness of the layers in the layered structure varies throughout the structure. The first SiO₂ layer is between 60 nm and 120 nm thick. The first ZrO₂ layer is between 5 nm and 60 nm thick. The second SiO₂ layer is between 20 nm and 100 nm thick. The second ZrO₂ layer is between 20 nm and 150 nm thick. The third SiO₂ layer is between 5 nm and 60 nm thick. The third ZrO₂ layer is between 20 nm and 100 nm thick. The first ITO layer is between 1 nm and 10 nm thick. The first Al₂O₃ layer is between 1 nm and 12 nm thick. Finally, the fourth SiO₂ layer is between 50 nm and 100 nm thick.

Optionally, the first SiO₂ layer is 100 nm thick, the first ZrO₂ layer is 40 nm thick, the second SiO₂ layer is 60 nm thick, the second ZrO₂ layer is 115 nm thick, the third SiO₂ layer is 40 nm thick, the third ZrO₂ layer is 55 nm thick, the first ITO layer is 5 nm thick, the first Al₂O₃ layer is 8 nm thick, and the fourth SiO₂ layer is 95 nm thick.

Optionally, the first SiO₂ layer is 95 nm thick, the first ZrO₂ layer is 45 nm thick, the second SiO₂ layer is 55 nm thick, the second ZrO₂ layer is 120 nm thick, the third SiO₂ layer is 35 nm thick, the third ZrO₂ layer is 60 nm thick, the first ITO layer is 6 nm thick, the first Al₂O₃ layer is 6 nm thick, and the fourth SiO₂ layer is 90 nm thick.

Optionally, the first SiO₂ layer is 85 nm thick, the first ZrO₂ layer is 35 nm thick, the second SiO₂ layer is 60 nm thick, the second ZrO₂ layer is 100 nm thick, the first ITO layer is 6 nm thick, the first Al₂O₃ layer is 6 nm thick, and the fourth SiO₂ layer is 85 nm thick. In this embodiment, the third SiO₂ layer and the third ZrO₂ layer are omitted from the anti-reflection coating.

An ultra-hydrophobic layer is disposed on each anti-reflection coating. The ultra-hydrophobic layer can have hydrophobic properties that can encourage water droplets on the lens (e.g., raindrops) to bead up and roll off the surface of the lens rather than spread out and form a thick layer of water that obscures the driver's vision. As a result, the ultra-hydrophobic layer can help maintain clear vision in wet conditions, which is particularly crucial for driving lenses where maximum visibility is essential.

Similarly, the ultra-hydrophobic layer can repel oil and dirt, which helps wearers keep their lenses cleaner for longer. Cleaner lenses improve visibility, which is crucial for glasses designed to be worn while driving. Additionally, lenses that stay cleaner for longer do not require frequent cleaning. This means wearers do not have to remove their glasses on a regular basis, which is another significant benefit for driving-specific eyewear. Finally, because the ultra-hydrophobic layer can help keep lenses clean, the ultra-hydrophobic layer can provide the added benefit of optimizing the function of the layers beneath it, which includes the anti-reflection coating.

The ultra-hydrophobic layer, as the outermost layer, can also serve to protect the layers beneath it from abrasion and wear. Driving lenses are exposed to a wide range of environmental stressors, and the ultra-hydrophobic layer can extend the life of the lenses by protecting the inner layers of the lenses against these stressors.

In some embodiments, the ultra-hydrophobic coating has a thickness between 5 nm and 105 nm. Optionally, the anti-fog layer has a thickness between 8 nm and 102 nm.

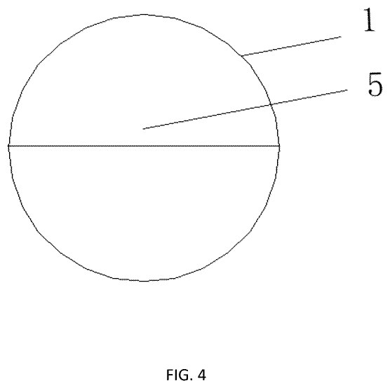

FIG. 4 illustrates a top view of a resin lens of the blue-light-reflecting eyeglass lens, according to some embodiments of the present disclosure. As shown, the vision optimization area 5 may only occupy a portion of the resin lens 1. In some embodiments, the vision optimization area 5 occupies the entire resin lens 1.

The vision optimization area can be a single lens (i.e., have one correction value) or a progressive lens (i.e., have at least two correction values).

The present disclosure also includes methods for manufacturing an eyeglass lens that limits visual fatigue caused by blue light exposure and glare from the headlights of other cars. Such a method may include providing a resin lens as previously described with respect to FIGS. 3 and 4. The method may further include selecting one or more appropriate correction values and surface grinding the resin lens to apply the appropriate correction values to the resin lens. Optionally, the surface grinding is surface processing completed by optical design software. The optical design software surface processes the resin lens to form a vision optimization area on the resin lens. The method may also include wiping the resin lens, cleaning the resin lens with ultrasonic waves, and drying the resin lens. A hardened layer may be dip coated onto both sides of the resin lens. The method may also include placing the resin lens with the hardened layer in a vacuum coating chamber and vacuum coating anti-reflection coatings onto both hardened layers. Vacuum coating the anti-reflection coating onto each of the hardened layers may include bombarding each of the hardened layers with Ar to activate each of the hardened layers and depositing on each of the hardened layers a layered structure of SiO₂, ZrO₂, ITO, and Al₂O₃, as described above with reference to FIGS. 3 and 4. The layered structure may be deposited onto the hardened layers with an electron gun. The ultra-hydrophobic coating is deposited onto each of the anti-reflection layers. The ultra-hydrophobic coating may be deposited using an electron gun or thermal evaporation.

Optionally, the lifting speed for the dip coating is between about 1.0 mm/s and 3.5 mm/s.

Optionally, depositing the anti-reflection coatings is done with an electron gun. Optionally, depositing the anti-reflection coatings is done by thermal evaporation.

Optionally, the vision optimization area is designed to enhance night vision. Optionally, the vision optimization enhances night vision by about-0.25 diopters to about-0.75 diopters.

Optionally, the night vision optimization area is applied on top of the ultra-hydrophobic coating.

The method for preparing blue-light-reflecting lenses requires an electron gun power of about 10% to 50%, a thermal evaporation power of about 10% to 15%, an anode voltage of about 90 Volts (V) to 120 V, an anode current of about 1 Ampere (A) to 3 A, an O2 flow rate between about 0 cm3/min and 36 cm3/min (in other words, 0 standard cubic centimeters per minute (sccm) and 36 sccm), and an Ar flow rate of between about 0 cm3/min and 51 cm3/min. Moreover, the evaporation rates for vacuum coating the anti-reflection layer is between about 0.3 nm/s and 3 nm/s for SiO₂, about 0.1 nm/s to 2 nm/s for ZrO₂, about 0.1 nm/s and 0.2 nm/s for ITO, and about 0.2 nm/s and 0.5 nm/s for Al₂O₃. Additionally, the evaporation rate for vacuum coating the ultra-hydrophobic coating is between about 0.1 nm/s and 0.5 nm/s.

In a first example, the dip coating lifting speed is about 1.5 mm/s. The first layer of SiO₂ has a thickness of 100 nm, the first layer of ZrO₂ has a thickness of 40 nm, the second layer of SiO₂ has a thickness of 60 nm, the second layer of ZrO₂ has a thickness of 115 nm, the third layer of SiO₂ has a thickness of 40 nm, the third layer of ZrO₂ has a thickness of 55 nm, the first layer of ITO has a thickness of 5 nm, the first layer of Al₂O₃ has a thickness of 8 nm, and the fourth layer of SiO₂ has a thickness of 95 nm. The vacuum coating chamber has a vacuum pressure of 1.0×10-3 Pascals (Pa), a temperature of about 40° C., an electron gun power of 35%, a thermal evaporation power of 15%, an anode voltage of 100 V, an anode current of 3 A, an O2 flow rate of 28 cm3/min, and an Ar flow rate of 40 cm3/min. For the thermal evaporation, the evaporation rate of SiO₂ is 1.3 nm/s, ZrO₂ is 0.6 nm/s, ITO is 0.1 nm/s, and Al₂O₃ is 0.2 nm/s. Furthermore, the ultra-hydrophobic coating has an evaporation rate of 0.2 mm/s. Finally, the anti-fog layer has a thickness of 20 nm.

In a second example, the dip coating lifting speed is about 2.5 mm/s. The first layer of SiO₂ has a thickness of 95 nm, the first layer of ZrO₂ has a thickness of 45 nm, the second layer of SiO₂ has a thickness of 55 nm, the second layer of ZrO₂ has a thickness of 120 nm, the third layer of SiO₂ has a thickness of 35 nm, the third layer of ZrO₂ has a thickness of 60 nm, the first layer of ITO has a thickness of 6 nm, the first layer of Al₂O₃ has a thickness of 6 nm, and the fourth layer of SiO₂ has a thickness of 90 nm. The vacuum coating chamber has a vacuum pressure of 1.0×10-4 Pascals (Pa), a temperature of about 40° C., an electron gun power of 20%, a thermal evaporation power of 10%, an anode voltage of 110 V, an anode current of 1.5 A, an O2 flow rate of 30 cm3/min, and an Ar flow rate of 36 cm3/min. For the thermal evaporation, the evaporation rate of SiO₂ is 1.5 nm/s, ZrO₂ is 0.5 nm/s, ITO is 0.1 nm/s, and Al₂O₃ is 0.3 nm/s. Furthermore, the ultra-hydrophobic coating has an evaporation rate of 0.2 mm/s. Finally, the anti-fog layer has a thickness of 20 nm.

In a third example, the dip coating lifting speed is about 2.0 mm/s. The first layer of SiO₂ has a thickness of 85 nm, the first layer of ZrO₂ has a thickness of 35 nm, the second layer of SiO₂ has a thickness of 60 nm, the second layer of ZrO₂ has a thickness of 100 nm, the first layer of ITO has a thickness of 6 nm, the first layer of Al₂O₃ has a thickness of 6 nm, and the fourth layer of SiO₂ has a thickness of 85 nm. In the third example, the anti-reflection coating does not have a third layer of SiO₂ or a third layer of ZrO₂. The vacuum coating chamber has a vacuum pressure of 1.0×10-3 Pascals (Pa), a temperature of about 40° C., an electron gun power of 35%, a thermal evaporation power of 12%, an anode voltage of 100 V, an anode current of 3 A, an O2 flow rate of 30 cm3/min, and an Ar flow rate of 40 cm3/min. For the thermal evaporation, the evaporation rate of SiO₂ is 2 nm/s, ZrO₂ is 0.8 nm/s, ITO is 0.1 nm/s, and Al₂O₃ is 0.3 nm/s. Furthermore, the ultra-hydrophobic coating has an evaporation rate of 0.1 nm/s. Finally, the anti-fog layer has a thickness of 20 nm.

In a fourth example, the resin lens, having a refraction index of about 1.61, is wiped clean. The resin lens undergoes surface grinding processing to allow for a single vision correction value. The processed lens is wiped cleaned, ultrasonic cleaned, dried, and dip coated with a hardened layer. An ordinary hard coating liquid is dip coated onto the lens at a lifing speed of about 2.0 mm/s.

The performance test results of each of these four examples as compared to the functional criterion is provided in Table 2.

TABLE 2
Performance Test Results of Examples 1-4

| | | Example | Example | Example | Example |
|---|---|---|---|---|---|
| | Criterion | 1 | 2 | 3 | 4 |
| Contact | ≥110° | 116° | 118° | 107° | 70° |
| angle | | | | | |
| Boil | ≥95% | OK | OK | OK | OK |
| adhesion | | | | | |
| Drop | Complies | OK | OK | OK | OK |
| ball | with | | | | |
| test | FDA | | | | |
| Surface | ≥5H | 7H | 7H | 7H | 6H |
| hardness | | | | | |
| τv | ≥75% | 92.07% | 92.46% | 95.81% | 89.41% |
| 380-780 nm | | | | | |
| 400-455 nm | ≥50% | 59.40% | 56.80% | 32.49% | 37.48% |
| Blocking | | | | | |
| rate, % | | | | | |
| 400-500 nm | ≥30% | 39.1% | 36.2% | 16.8% | 23.12% |
| Blocking | | | | | |
| rate, % | | | | | |
| τv 585 nm | 85% ± 2% | 85.41% | 85.23% | 96.56% | 88.96% |
| Hard | Three | OK | OK | OK | OK |
| coating | months | | | | |
| Reliability | | | | | |
| Daylight or | No visual | NG | OK | NG | NG |
| sunny | inter- | | | | |
| | ference | | | | |
| Night or | No visual | OK | OK | NG | NG |
| dark | inter- | | | | |
| | ference | | | | |

The anti-glare lenses reflect high-energy blue light. In particular, the anti-glare lenses reflect at least 50% of blue light in the 400 nm to 455 nm wavelength range and at least 30% of blue light in the 400 nm to 500 nm wavelength range. This blue light reflection limits vision fatigue experienced by a wearer of the anti-glare lenses. At the same time, the anti-glare lenses transmit at least 90% of beneficial visible light for driving safety and comfort.

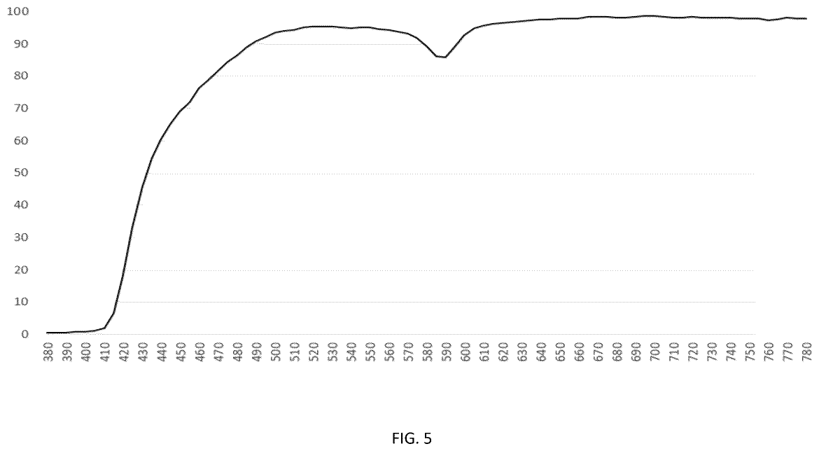

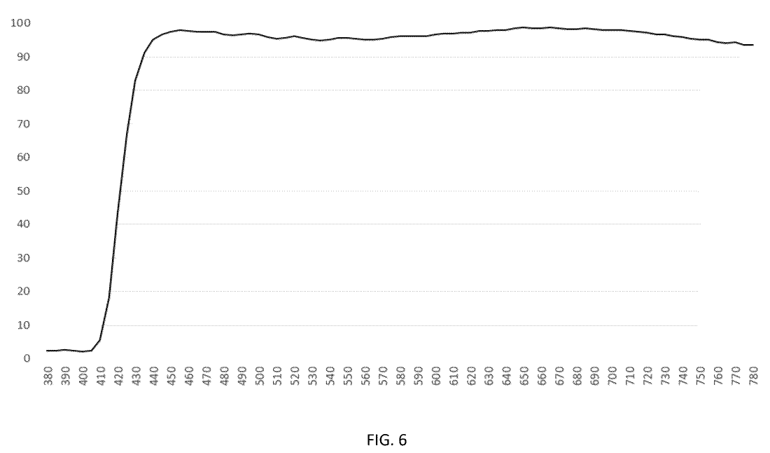

Referring now to FIGS. 5 and 6, the visible light spectrum can be transmitted through the blue-light-reflecting lens in use, and FIGS. 5 and 6 illustrate the exceptional performance of the presently disclosed blue-light-reflecting lens, according to some embodiments. Although the values are representative of the noteworthy anti-near-infrared radiation coating having the properties disclosed above in examples 1 and 3, these values are also representative of various other coatings that might be arranged or configured slightly differently than the noteworthy anti-near-infrared radiation coating.

FIG. 5 illustrates the spectrum of radiation that is transmitted by the first example of the blue-light-reflecting eyeglass lens, according to some embodiments of the present disclosure. The curve in FIG. 5 can be analyzed to calculate the percentage of blue light that is reflected by the eyeglass lens. Such calculations obtain the area under the curve (transmitted visible light, including blue light) compared to the area above the curve (reflected visible light, including blue light). These calculations demonstrate that the blue-light-reflecting eyeglass lenses of the first example reflect an average of 39% of the blue light wavelength range of about 410 nm to 500 nm. At the same time, the blue-light-reflecting eyeglass lenses of the first example allow transmittance of 95% to 98% of the remainder of the visible light spectrum.

FIG. 6 illustrates the spectrum of radiation that is transmitted by the third example of the blue-light-reflecting eyeglass lens, according to some embodiments of the present disclosure. The calculations conducted on the curve in FIG. 5 can also be applied to the curve in FIG. 6. The calculations demonstrate that the blue-light-reflecting eyeglass lenses of the third example reflect an average of 31% of the blue light wavelength range of about 410 nm to 455 nm, which is the portion of the blue light spectrum with the highest intensity (i.e., the portion of the blue light spectrum that is most likely to cause vision fatigue). At the same time, the blue-light-reflecting eyeglass lenses of the third example allow transmittance of 93% to 98% of the remainder of the visible light spectrum.

### Illustration of Subject Technology as Clauses

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.

Clause 1. An eyeglass lens that is resistant to condensation, the lens comprising: a resin lens, the resin lens comprising a first surface and a second surface opposite the first surface; a hardened layer disposed on each of the first surface and/or the second surface of the resin lens; an anti-reflection coating disposed on each of the hardened layers, the anti-reflection coating comprising a layered structure of a first SiO₂ layer, a first ZrO₂ layer, a second SiO₂ layer, a second ZrO₂ layer, a first ITO layer, a first Al₂O₃ layer, and a third SiO₂ layer; and an anti-fog layer disposed on each of the anti-reflection coatings.

Clause 2. An eyeglass lens that is resistant to condensation, the lens comprising: a resin lens, the resin lens comprising a first surface and a second surface opposite the first surface; a hardened layer disposed on each of the first surface and/or the second surface of the resin lens; an anti-reflection coating disposed on each of the hardened layers, the anti-reflection coating comprising: a first SiO₂ layer having a thickness between 105 nm and 130 nm, a first ZrO₂ layer having a thickness between 20 nm and 35 nm, a second SiO₂ layer having a thickness between 15 nm and 25 nm, a second ZrO₂ layer having a thickness between 40 nm and 55 nm, a first ITO layer having a thickness between 1 nm and 15 nm, a first Al₂O₃ layer having a thickness between 1 nm and 15 nm, a third SiO₂ layer having a thickness between 50 nm and 70 nm; and one or more anti-fog layers disposed on each of the anti-reflection coatings.

Clause 3. An anti-reflection coating for an eyeglass lens that is resistant to condensation, the anti-reflection coating comprising a layered structure having at least seven individual layers, wherein each layer of the layered structure comprises SiO₂, ZrO₂, ITO, or Al₂O₃.

Clause 4. The eyeglass lens of any of the preceding Clauses, wherein the resin lens comprises a hardened resin lens.

Clause 5. The eyeglass lens of any of the preceding Clauses, wherein the first and second surfaces of the resin lens are activated by ion bombardment.

Clause 6. The eyeglass lens of any of the preceding Clauses, wherein the hardened layer is evenly distributed on the first and/or second surfaces of the resin lens.

Clause 7. The eyeglass lens of any of the preceding Clauses, wherein the hardened layer is wear-resistant.

Clause 8. The eyeglass lens of any of the preceding Clauses, wherein the hardened layer is a wear-resistant hardened layer dip coated on the first and/or second surfaces of the resin lens.

Clause 9. The eyeglass lens of any of the preceding Clauses, wherein the hardened layer has a higher density than the resin lens.

Clause 10. The anti-reflection coating of any of the preceding Clauses, wherein, in order of layering, the first layer, the third layer, and the seventh layer each comprise SiO₂.

Clause 11. The anti-reflection coating of any of the preceding Clauses, wherein, in order of layering, the second and fourth layers each comprise ZrO₂.

Clause 12. The anti-reflection coating of any of the preceding Clauses, wherein, in order of layering, the fifth layer comprises ITO.

Clause 13. The anti-reflection coating of any of the preceding Clauses, wherein, in order of layering, the sixth layer comprises Al₂O₃.

Clause 14. The anti-reflection coating of any of the preceding Clauses, wherein the layered structure is arranged with the first SiO₂ layer being nearest the resin lens and the third SiO₂ layer being farthest away from the resin lens.

Clause 15. The anti-reflection coating of any of the preceding Clauses, wherein the first SiO₂ layer has a thickness between 110 nm and 125 nm.

Clause 16. The anti-reflection coating of any of the preceding Clauses, wherein the first ZrO₂ layer has a thickness between 20 nm and 35 nm.

Clause 17. The anti-reflection coating of any of the preceding Clauses, wherein the second SiO₂ layer has a thickness between 15 nm and 25 nm.

Clause 18. The anti-reflection coating of any of the preceding Clauses, wherein the second ZrO₂ layer has a thickness between 40 nm and 55 nm.

Clause 19. The anti-reflection coating of any of the preceding Clauses, wherein the first ITO layer has a thickness between 4 nm and 12 nm.

Clause 20. The anti-reflection coating of any of the preceding Clauses, wherein the first Al₂O₃ layer has a thickness between 4 nm and 12 nm.

Clause 21. The anti-reflection coating of any of the preceding Clauses, wherein the third SiO₂ layer has a thickness between 45 nm and 70 nm.

Clause 22. The anti-reflection coating of any of the preceding Clauses, wherein a Ti₃O₅ layer is disposed between the anti-reflection coating and the anti-fog layer, the Ti₃O₅ layer having a thickness between 20 nm and 40 nm.

Clause 23. The anti-reflection coating of any of the preceding Clauses, wherein a Ti₃O₅ layer is disposed between the anti-reflection coating and the anti-fog layer, the Ti₃O₅ layer having a thickness of 30 nm.

Clause 24. The eyeglass lens of any of the preceding Clauses, wherein each of the anti-reflection coatings are activated by ion bombardment.

Clause 25. The eyeglass lens of any of the preceding Clauses, wherein the anti-fog layer has a thickness between 5 nm and 105 nm.

Clause 26. The eyeglass lens of any of the preceding Clauses, wherein the anti-fog layer has a thickness between 8 nm and 102 nm.

Clause 27. The eyeglass lens of any of the preceding Clauses, wherein the anti-fog layer comprises a silicone polymer.

Clause 28. The eyeglass lens of any of the preceding Clauses, wherein the anti-fog layer comprises an organic silicone polymer film layer that is deposited on the anti-reflection coating by thermal evaporation.

Clause 29. The eyeglass lens of any of the preceding Clauses, wherein a layer of HT-100 is disposed on each of the anti-fog layers, the HT-100 layer having a thickness between 10 nm and 20 nm.

Clause 30. The eyeglass lens of any of the preceding Clauses, wherein a layer of HT-100 is disposed on each of the anti-fog layers, the HT-100 layer having a thickness of about 15 nm.

Clause 31. A method for manufacturing an eyeglass lens that is resistant to condensation, the method comprising: providing a resin lens comprising a first surface and a second surface opposite the first surface; applying, to the first surface and/or the second surface of the resin lens, a hardened layer; depositing, on each of the hardened layers, an anti-reflection coating, the anti-reflection coating comprising a first SiO₂ layer, a first ZrO₂ layer, a second SiO₂ layer, a second ZrO₂ layer, a first ITO layer, a first Al₂O₃ layer, and a third SiO₂ layer; and depositing an anti-fog layer on each of the anti-reflection coatings.

Clause 32. A method for manufacturing an eyeglass lens that is resistant to condensation, the method comprising: providing a resin lens comprising a first surface and a second surface opposite the first surface; cleaning the resin lens with ultrasonic waves; drying the resin lens; cooling the resin lens to room temperature; applying, to the first surface and/or the second surface of the resin lens, a hardened layer; placing the resin lens in a vacuum coating chamber; vacuum coating each of the hardened layers with an anti-reflection coating, wherein vacuum coating comprises: bombarding each of the hardened layers with Ar to activate each of the hardened layers; and depositing, with an electron gun, the anti-reflection coating on each of the hardened layers, wherein the anti-reflection coating comprises a first SiO₂ layer, a first ZrO₂ layer, a second SiO₂ layer, a second ZrO₂ layer, a first ITO layer, a first Al₂O₃ layer, and a third SiO₂ layer; vacuum coating each of the anti-reflection coatings with an anti-fog layer, wherein vacuum coating comprises: bombarding each of the anti-reflection coatings with Ar to activate each of the anti-reflection coatings; and depositing, by thermal evaporation, the anti-fog layer on each of the anti-reflection coatings.

Clause 33. A method for manufacturing an eyeglass lens that is resistant to condensation, the method comprising: providing a resin lens comprising a first surface and a second surface opposite the first surface; applying, to the first surface and/or the second surface of the resin lens, a hardened layer; placing the resin lens in a vacuum coating chamber; vacuum coating each of the hardened layers with an anti-reflection coating, wherein vacuum coating comprises: bombarding each of the hardened layers with Ar to activate each of the hardened layers; and depositing, with an electron gun, the anti-reflection coating on each of the hardened layers, wherein the anti-reflection coating comprises: a first SiO₂ layer having a thickness between 105 nm and 130 nm, a first ZrO₂ layer having a thickness between 20 nm and 35 nm, a second SiO₂ layer having a thickness between 15 nm and 25 nm, a second ZrO₂ layer having a thickness between 40 nm and 55 nm, a first ITO layer having a thickness between 1 nm and 15 nm, a first Al₂O₃ layer having a thickness between 1 nm and 15 nm, and a third SiO₂ layer having a thickness between 50 nm and 70 nm; and vacuum coating each of the anti-reflection coatings with an anti-fog layer, wherein the vacuum coating comprises: bombarding each of the anti-reflection coatings with Ar to activate each of the anti-reflection coatings; and depositing, by thermal evaporation, the anti-fog layer on each of the anti-reflection coatings.

Clause 34. A method for applying an anti-reflection coating to an eyeglass lens that is resistant to condensation, the method comprising: providing a lens; placing the lens in a vacuum coating chamber; and depositing, with an electron gun, the anti-reflection coating on each of the hardened layers, wherein the anti-reflection coating comprises a layered structure having at least seven individual layers, wherein each layer of the layered structure comprises SiO₂, ZrO₂ ITO, or Al₂O₃.

Clause 35. The method of Clause 32, wherein drying the resin lens comprises placing the resin lens in an oven.

Clause 36. The method of Clause 35, wherein the oven has a temperature between 50° C. and 70° C.

Clause 37. The method of Clause 35, wherein the oven has a temperature of about 60° C.

Clause 38. The method of Clause 35, wherein placing the resin lens in the oven comprises placing the resin lens in the oven for a time between 20 minutes and 40 minutes.

Clause 39. The method of Clause 35, wherein placing the resin lens in the oven comprises placing the resin lens in the oven for a time of about 30 minutes.

Clause 40. The method of any of Clauses 31 to 39, wherein placing the resin lens in the vacuum coating chamber comprises placing the resin lens in the vacuum coating chamber with a temperature between 30° C. and 60° C.

Clause 41. The method of any of Clauses 31 to 40, wherein placing the resin lens in the vacuum coating chamber comprises placing the resin lens in the vacuum coating chamber with a temperature between 34° C. and 56° C.

Clause 42. The method of any of Clauses 31 to 41, wherein placing the resin lens in the vacuum coating chamber comprises placing the resin lens in the vacuum coating chamber with a pressure between 1.0×10⁻² Pa and 1.0×10⁻⁶ Pa.

Clause 43. The method of any of Clauses 31 to 42, wherein placing the resin lens in the vacuum coating chamber comprises placing the resin lens in the vacuum coating chamber with a pressure between 0.9×10⁻³ Pa and 0.9×10⁻⁵ Pa.

Clause 44. The method of any of Clauses 31 to 43, wherein applying a hardened layer to the first surface and/or the second surface of the resin lens comprises dip coating a wear-resistant hardened layer on the resin lens.

Clause 45. The method of any of Clauses 31 to 44, wherein vacuum coating each of the hardened layers with an anti-reflection coating comprises thermal evaporating at a power between 5% and 20%.

Clause 46. The method of any of Clauses 31 to 45, wherein vacuum coating each of the hardened layers with an anti-reflection coating comprises thermal evaporating at a power between 9% and 16%

Clause 47. The method of any of Clauses 31 to 46, wherein vacuum coating each of the hardened layers with an anti-reflection coating comprises setting the vacuum coating chamber to have an anode voltage between 80 V and 130 V.

Clause 48. The method of any of Clauses 31 to 47, wherein vacuum coating each of the hardened layers with an anti-reflection coating comprises setting the vacuum coating chamber to have an anode voltage between 89 V and 121 V.

Clause 49. The method of any of Clauses 31 to 48, wherein vacuum coating each of the hardened layers with an anti-reflection coating comprises setting the vacuum coating chamber to have an anode current between 0.5 A and 4 A.

Clause 50. The method of any of Clauses 31 to 49, wherein vacuum coating each of the hardened layers with an anti-reflection coating comprises setting the vacuum coating chamber to have an anode voltage between 0.9 A and 3.1 A.

Clause 51. The method of any of Clauses 31 to 50, wherein vacuum coating each of the hardened layers with an anti-reflection coating comprises setting the vacuum coating chamber to have an O₂ flow rate less than 40 cm³/min.

Clause 52. The method of any of Clauses 31 to 51, wherein vacuum coating each of the hardened layers with an anti-reflection coating comprises setting the vacuum coating chamber to have an O₂ flow rate between 0 cm³/min and 31 cm³/min.

Clause 53. The method of any of Clauses 31 to 52, wherein vacuum coating each of the hardened layers with an anti-reflection coating comprises setting the vacuum coating chamber to have an Ar flow rate less than or equal to 60 cm³/min.

Clause 54. The method of any of Clauses 31 to 53, wherein vacuum coating each of the hardened layers with an anti-reflection coating comprises setting the vacuum coating chamber to have an Ar flow rate between 0 cm³/min and 51 cm³/min.

Clause 55. The method of any of Clauses 31 to 54, wherein depositing, with an electron gun, the anti-reflection coating comprises using an electron gun with a power of 5% to 55%.

Clause 56. The method of any of Clauses 31 to 55, wherein depositing, with an electron gun, the anti-reflection coating comprises using an electron gun with a power of 9% to 51%.

Clause 57. The method of any of Clauses 31 to 56, wherein depositing, with an electron gun, the anti-reflection coating comprises depositing SiO₂ at an evaporation rate between 0.1 nm/s and 3.5 nm/s.

Clause 58. The method of any of Clauses 31 to 57, wherein depositing, with an electron gun, the anti-reflection coating comprises depositing SiO₂ at an evaporation rate between 0.29 nm/s and 3.1 nm/s.

Clause 59. The method of any of Clauses 31 to 58, wherein depositing, with an electron gun, the anti-reflection coating comprises depositing ZrO₂ at an evaporation rate of less than 3 nm/s nm/s.

Clause 60. The method of any of Clauses 31 to 59, wherein depositing, with an electron gun, the anti-reflection coating comprises depositing ZrO₂ at an evaporation rate between 0.09 nm/s and 2.1 nm/s.

Clause 61. The method of any of Clauses 31 to 60, wherein depositing, with an electron gun, the anti-reflection coating comprises depositing Al₂O₃ at an evaporation rate between 0.1 nm/s and 1.1 nm/s.

Clause 62. The method of any of Clauses 31 to 61, wherein depositing, with an electron gun, the anti-reflection coating comprises depositing Al₂O₃ at an evaporation rate of about 0.5 nm/s.

Clause 63. The method of any of Clauses 31 to 62, wherein bombarding each of the anti-reflection coatings with Ar comprises bombarding each of the anti-reflection coatings with Ar for a time between 1 minute and 15 minutes.

Clause 64. The method of any of Clauses 31 to 63, wherein bombarding each of the anti-reflection coatings with Ar comprises bombarding each of the anti-reflection coatings with Ar for a time between about 2 minutes and about 10 minutes.

Clause 65. The method of any of Clauses 31 to 64, wherein depositing, by thermal evaporation, the anti-fog layer comprises depositing the anti-fog layer with a thickness between 5 nm and 105 nm.

Clause 66. The method of any of Clauses 31 to 65, wherein depositing, by thermal evaporation, the anti-fog layer comprises depositing the anti-fog layer with a thickness between 9 nm and 101 nm.

Clause 67. The method of any of Clauses 31 to 66, wherein depositing, by thermal evaporation, the anti-fog layer comprises depositing the anti-fog layer at an evaporation rate between 0.05 nm/s and 0.5 nm/s.

Clause 68. The method of any of Clauses 31 to 67, wherein depositing, by thermal evaporation, the anti-fog layer comprises depositing the anti-fog layer at an evaporation rate of about 0.12 nm/s.

Clause 69. An eyeglass lens that is resistant to condensation, wherein the lens is manufactured according to the method of any of Clauses 31 to 68.

Clause 70. An eyeglass lens that limits visual fatigue caused by blue light exposure, the lens comprising: a resin lens, wherein the resin lens comprises a first surface and a second surface opposite the first surface; a hard coating disposed on the first surface and the second surface of the resin lens; an anti-reflection coating disposed on each of the hard coatings, the anti-reflection coating comprising a first SiO₂ layer, a first ZrO₂ layer, a second SiO₂ layer, a second ZrO₂ layer, a third SiO₂ layer, a third ZrO₂ layer, a first ITO layer, a first Al₂O₃ layer, and a fourth SiO₂ layer; an ultra-hydrophobic coating disposed on each of the anti-reflection coatings; and a vision optimization area.

Clause 71. An eyeglass lens that limits visual fatigue caused by blue light exposure, the lens comprising: a resin lens, wherein the resin lens comprises a first surface and a second surface opposite the first surface; a hard coating disposed on the first surface and the second surface of the resin lens; an anti-reflection coating disposed on each of the hard coatings, the anti-reflection coating comprising: a first SiO₂ layer having a thickness between 60 nm and 120 nm, a first ZrO₂ layer having a thickness between 5 nm and 60 nm, a second SiO₂ layer having a thickness between 20 nm and 100 nm, a second ZrO₂ layer having a thickness between 20 nm and 150 nm, a third SiO₂ layer having a thickness between 5 nm and 60 nm, a third ZrO₂ layer having a thickness between 20 nm and 100 nm, a first ITO layer having a thickness between 1 nm and 10 nm, a first Al₂O₃ layer having a thickness between 1 nm and 12 nm, a fourth SiO₂ layer having a thickness between 50 nm and 100 nm; an ultra-hydrophobic coating disposed on each of the anti-reflection coatings; and a vision optimization area.

Clause 72. An anti-reflection coating for an eyeglass lens that limits visual fatigue caused by blue light exposure, the anti-reflection coating comprising a layered structure having at least seven individual layers, wherein each layer of the layered structure comprises SiO₂, ZrO₂, ITO, or Al₂O₃.

Clause 73. The eyeglass lens of any of Clauses 70 to 72, wherein the resin lens comprises a blue light blocking resin lens.

Clause 74. The eyeglass lens of any of Clauses 70 to 73, wherein the resin lens comprises a blue light blocking resin lens with a refraction index between 1.20 and 2.00.

Clause 75. The eyeglass lens of any of Clauses 70 to 74, wherein the resin lens comprises a blue light blocking resin lens with a refraction index between 1.40 and 1.80.

Clause 76. The eyeglass lens of any of Clauses 70 to 75, wherein the hard coating is dip coated on the first and second surfaces of the resin lens.

Clause 77. The eyeglass lens of any of Clauses 70 to 76, wherein the hard coating comprises an organosilicon hard coating liquid.

Clause 78. The eyeglass lens of any of Clauses 70 to 77, wherein the hard coating comprises 0.001% to 0.1% yellow light absorber.

Clause 79. The eyeglass lens of any of Clauses 70 to 78, wherein the hard coating comprises about 0.008% yellow light absorber.

Clause 80. The eyeglass lens of any of Clauses 70 to 79, wherein the hard coating comprises about 0.015% yellow light absorber.

Clause 81. The yellow light absorber of any of Clauses 78 to 80, wherein the yellow light absorber absorbs light at a wavelength between 500 nm and 650 nm.

Clause 82. The yellow light absorber of any of Clauses 78 to 80, wherein the yellow light absorber absorbs light at a wavelength between 550 nm and 600 nm.

Clause 83. The eyeglass lens of any of Clauses 78 to 80, wherein the hard coating is configured to absorb light at a wavelength of about 585 nm.

Clause 84. The eyeglass lens of any of Clauses 70 to 83, wherein the hardened layer is activated by ion bombardment.

Clause 85. The anti-reflection coating of any of Clauses 70 to 84, wherein, in order of layering, the first layer, the third layer, the fifth layer, and the ninth layer each comprise SiO₂.

Clause 86. The anti-reflection coating of any of Clauses 70 to 85, wherein, in order of layering, the second layer, the fourth layer, and the sixth layer each comprise ZrO₂.

Clause 87. The anti-reflection coating of any of Clauses 70 to 86, wherein, in order of layering, the seventh layer comprises ITO.

Clause 88. The anti-reflection coating of any of Clauses 70 to 87, wherein, in order of layering, the eighth layer comprises Al₂O₃.

Clause 89. The anti-reflection coating of any of Clauses 70 to 88, wherein the layered structure is arranged with the first SiO₂ layer being nearest the resin lens in the fourth SiO₂ layer being farthest away from the resin lens.

Clause 90. The anti-reflection coating of any of Clauses 70 to 89, wherein the first SiO₂ layer has a thickness between 80 nm and 110 nm.

Clause 91. The anti-reflection coating of any of Clauses 70 to 90, wherein the first ZrO₂ layer has a thickness between 30 nm and 50 nm.

Clause 92. The anti-reflection coating of any of Clauses 70 to 91, wherein the second SiO₂ layer has a thickness between 50 nm and 65 nm.

Clause 93. The anti-reflection coating of any of Clauses 70 to 92, wherein the second ZrO₂ layer has a thickness between 90 nm and 130 nm.

Clause 94. The anti-reflection coating of any of Clauses 70 to 93, wherein the third SiO₂ layer has a thickness between 30 nm and 45 nm.

Clause 95. The anti-reflection coating of any of Clauses 70 to 94, wherein the third ZrO₂ layer has a thickness between 50 nm and 65 nm.

Clause 96. The anti-reflection coating of any of Clauses 70 to 95, wherein the first ITO layer has a thickness between 2 nm and 8 nm.

Clause 97. The anti-reflection coating of any of Clauses 70 to 96, wherein the first Al₂O₃ layer has a thickness between 2 nm and 10 nm.

Clause 98. The anti-reflection coating of any of Clauses 70 to 97, wherein the fourth SiO₂ layer has a thickness between 65 nm and 85 nm.

Clause 99. The eyeglass lens of any of Clauses 70 to 98, wherein the anti-reflection coatings are activated by ion bombardment.

Clause 100. The eyeglass lens of any of Clauses 70 to 99, wherein the ultra-hydrophobic layer has a thickness between 5 nm and 105 nm.

Clause 101. The eyeglass lens of any of Clauses 70 to 100, wherein the ultra-hydrophobic layer has a thickness between 9 nm and 101 nm.

Clause 102. The eyeglass lens of any of Clauses 70 to 101, wherein the ultra-hydrophobic layer has a water drop angle greater than or equal to 110°.

Clause 103. The eyeglass lens of any of Clauses 70 to 102, wherein the ultra-hydrophobic layer has a water drop angle greater than or equal to 115°.

Clause 104. The eyeglass lens of any of Clauses 70 to 103, wherein the lens is configured to reflect light in a wavelength range between 380 nm and 520 nm.

Clause 105. The eyeglass lens of any of Clauses 70 to 104, wherein the lens is configured to reflect at least 50% of light in a wavelength range between 380 nm and 475 nm.

Clause 106. The eyeglass lens of any of Clauses 70 to 105, wherein the lens is configured to reflect at least 50% of light in a wavelength range between 400 nm and 455 nm.

Clause 107. The eyeglass lens of any of Clauses 70 to 106, wherein the lens is configured to reflect at least 30% of light in a wavelength range between 380 nm and 520 nm.

Clause 108. The eyeglass lens of any of Clauses 70 to 107, wherein the lens is configured to reflect at least 30% of light in a wavelength range between 400 nm and 500 nm.

Clause 109. The eyeglass lens of any of Clauses 70 to 108, wherein the vision optimization area comprises one correction value.

Clause 110. The eyeglass lens of any of Clauses 70 to 109, wherein the vision optimization area comprises at least two correction values.

Clause 111. The eyeglass lens of any of Clauses 70 to 110, wherein the vision optimization area is configured to enhance night vision.

Clause 112. The eyeglass lens of any of Clauses 70 to 111, wherein the lens comprises a surface hardness of at least 5 H.

Clause 113. The eyeglass lens of any of Clauses 70 to 112, wherein the lens comprises a surface hardness of about 7 H.

Clause 114. A method for manufacturing an eyeglass lens that limits visual fatigue caused by blue light exposure, the method comprising: providing a resin lens comprising a first surface and a second surface opposite the first surface, and a vision optimization area; applying, to the first surface and the second surface, a hard coating; depositing, on each of the hard coatings, an anti-reflection coating, the anti-reflection coating comprising a first SiO₂ layer, a first ZrO₂ layer, a second SiO₂ layer, a second ZrO₂ layer, a third SiO₂ layer, a third ZrO₂ layer, a first ITO layer, a first Al₂O₃ layer, and a fourth SiO₂ layer; depositing an ultra-hydrophobic coating on each of the anti-reflection coatings; and applying a vision optimization area to each of the ultra-hydrophobic coatings.

Clause 115. A method for manufacturing an eyeglass lens that limits visual fatigue caused by blue light exposure, the method comprising: providing a resin lens comprising a first surface and a second surface opposite the first surface; selecting one or more appropriate correction values; surface grinding the resin lens to apply the appropriate correction values to the resin lens; wiping the resin lens; cleaning the resin lens with ultrasonic waves; drying the resin lens; dip coating the first surface and the second surface with a hard coating; placing the resin lens in a vacuum coating chamber; vacuum coating each of the hardened layers with an anti-reflection coating, wherein vacuum coating comprises: bombarding each of the hardened layers with Ar to activate each of the hardened layers; and depositing, with an electron gun, the anti-reflection coating on each of the hardened layers, wherein the anti-reflection coating comprises a first SiO₂ layer, a first ZrO₂ layer, a second SiO₂ layer, a second ZrO₂ layer, a third SiO₂ layer, a third ZrO₂ layer, a first ITO layer, a first Al₂O₃ layer, and a fourth SiO₂ layer; depositing, by thermal evaporation, an ultra-hydrophobic coating on each of the anti-reflection coatings; and applying a vision optimization area to each of the ultra-hydrophobic coatings.

Clause 116. A method for manufacturing an eyeglass lens that limits visual fatigue caused by blue light exposure, the method comprising: providing a resin lens comprising a first surface and a second surface opposite the first surface, and a vision optimization area; wiping the resin lens; cleaning the resin lens with ultrasonic waves; drying the resin lens; dip coating the first surface and the second surface with a hard coating; placing the resin lens in a vacuum coating chamber; vacuum coating each of the hardened layers with an anti-reflection coating, wherein vacuum coating comprises: bombarding each of the hardened layers with Ar to activate each of the hardened layers; and depositing, with an electron gun, the anti-reflection coating on each of the hardened layers, wherein the anti-reflection coating comprises a first SiO₂ layer, a first ZrO₂ layer, a second SiO₂ layer, a second ZrO₂ layer, a third SiO₂ layer, a third ZrO₂ layer, a first ITO layer, a first Al₂O₃ layer, and a fourth SiO₂ layer; depositing, by thermal evaporation, an ultra-hydrophobic coating on each of the anti-reflection coatings; and applying a vision optimization area to each of the ultra-hydrophobic coatings.

Clause 117. A method for manufacturing an eyeglass lens that limits visual fatigue caused by blue light exposure, the method comprising: providing a resin lens comprising a first surface and a second surface opposite the first surface, and a vision optimization area; dip coating the first surface and the second surface with a hard coating; placing the resin lens in a vacuum coating chamber; vacuum coating each of the hardened layers with an anti-reflection coating, wherein vacuum coating comprises: bombarding each of the hardened layers with Ar to activate each of the hardened layers; and depositing, with an electron gun, the anti-reflection coating on each of the hardened layers, wherein the anti-reflection coating comprises: a first SiO₂ layer having a thickness between 60 nm and 120 nm, a first ZrO₂ layer having a thickness between 5 nm and 60 nm, a second SiO₂ layer having a thickness between 20 nm and 100 nm, a second ZrO₂ layer having a thickness between 20 nm and 150 nm, a third SiO₂ layer having a thickness between 5 nm and 60 nm, a third ZrO₂ layer having a thickness between 20 nm and 100 nm, a first ITO layer having a thickness between 1 nm and 10 nm, a first Al₂O₃ layer having a thickness between 1 nm and 12 nm, a fourth SiO₂ layer having a thickness between 50 nm and 100 nm; and depositing, by thermal evaporation, an ultra-hydrophobic coating on each of the anti-reflection coatings; and applying a vision optimization area to each of the ultra-hydrophobic coatings.

Clause 118. A method for manufacturing an eyeglass lens that limits visual fatigue caused by blue light exposure, the method comprising: providing a lens; placing the lens in a vacuum coating chamber; and depositing, with an electron gun, the anti-reflection coating on each of the hardened layers, wherein the anti-reflection coating comprises a layered structure having at least nine individual layers, wherein each layer of the layered structure comprises SiO₂, ZrO₂ ITO, or Al₂O₃.

Clause 119. The method of any of Clauses 114 to 118, wherein dip coating the first surface and the second surface comprises dip coating at a lifting speed between 0.5 mm/s and 4.0 mm/s.

Clause 120. The method of any of Clauses 114 to 119, wherein dip coating the first surface and the second surface comprises dip coating at a lifting speed between 0.9 mm/s and 3.6 mm/s.

Clause 121. The method of any of Clauses 114 to 120, wherein the hard coating comprises an organosilicon hard coating liquid.

Clause 122. The method of any of Clauses 114 to 121, wherein the hard coating comprises 0.001% to 0.1% yellow light absorber.

Clause 123. The method of any of Clauses 114 to 122, wherein the hard coating comprises about 0.008% yellow light absorber.

Clause 124. The method of any of Clauses 114 to 123, wherein the hard coating comprises about 0.015% yellow light absorber.

Clause 125. The method of any of Clauses 114 to 124, wherein the yellow light absorber absorbs light at a wavelength between 500 nm and 650 nm.

Clause 126. The method of any of Clauses 114 to 125, wherein the yellow light absorber absorbs light at a wavelength between 550 nm and 600 nm.

Clause 127. The method of any of Clauses 114 to 126, wherein the yellow light absorber absorbs light at a wavelength of about 585 nm.

Clause 128. The method of any of Clauses 114 to 127, wherein placing the resin lens in the vacuum coating chamber comprises placing the resin lens in the vacuum coating chamber with a temperature between 30° C. and 60° C.

Clause 129. The method of any of Clauses 114 to 128, wherein placing the resin lens in the vacuum coating chamber comprises placing the resin lens in the vacuum coating chamber with a temperature between 34° C. and 56° C.

Clause 130. The method of any of Clauses 114 to 129, wherein placing the resin lens in the vacuum coating chamber comprises placing the resin lens in the vacuum coating chamber with a pressure between 3.0×10⁻² Pa and 3.0×10⁻⁶ Pa.

Clause 131. The method of any of Clauses 114 to 130, wherein placing the resin lens in the vacuum coating chamber comprises placing the resin lens in the vacuum coating chamber with a pressure between 0.9×10⁻³ Pa and 2.9×10⁻⁵ Pa.

Clause 132. The method of any of Clauses 114 to 131, wherein vacuum coating each of the hardened layers with an anti-reflection coating comprises thermal evaporating at a power between 5% and 20%.

Clause 133. The method of any of Clauses 114 to 132, wherein vacuum coating each of the hardened layers with an anti-reflection coating comprises thermal evaporating at a power between 9% and 16%

Clause 134. The method of any of Clauses 114 to 133, wherein vacuum coating each of the hardened layers with an anti-reflection coating comprises setting the vacuum coating chamber to have an anode voltage between 80 V and 130 V.

Clause 135. The method of any of Clauses 114 to 134, wherein vacuum coating each of the hardened layers with an anti-reflection coating comprises setting the vacuum coating chamber to have an anode voltage between 89 V and 121 V.

Clause 136. The method of any of Clauses 114 to 135, wherein vacuum coating each of the hardened layers with an anti-reflection coating comprises setting the vacuum coating chamber to have an anode current between 0.5 A and 4 A.

Clause 137. The method of any of Clauses 114 to 136, wherein vacuum coating each of the hardened layers with an anti-reflection coating comprises setting the vacuum coating chamber to have an anode voltage between 0.9 A and 3.1 A.

Clause 138. The method of any of Clauses 114 to 137, wherein vacuum coating each of the hardened layers with an anti-reflection coating comprises setting the vacuum coating chamber to have an O₂ flow rate less than 45 cm³/min.

Clause 139. The method of any of Clauses 114 to 138, wherein vacuum coating each of the hardened layers with an anti-reflection coating comprises setting the vacuum coating chamber to have an O₂ flow rate between 0 cm³/min and 36 cm³/min.

Clause 140. The method of any of Clauses 114 to 139, wherein vacuum coating each of the hardened layers with an anti-reflection coating comprises setting the vacuum coating chamber to have an Ar flow rate less than or equal to 60 cm³/min.

Clause 141. The method of any of Clauses 114 to 140, wherein vacuum coating each of the hardened layers with an anti-reflection coating comprises setting the vacuum coating chamber to have an Ar flow rate between 0 cm³/min and 51 cm³/min.

Clause 142. The method of any of Clauses 114 to 141, wherein depositing, with an electron gun, the anti-reflection coating comprises using an electron gun with a power of 5% to 55%.

Clause 143. The method of any of Clauses 114 to 142, wherein depositing, with an electron gun, the anti-reflection coating comprises using an electron gun with a power of 9% to 51%.

Clause 144. The method of any of Clauses 114 to 143, wherein depositing, with an electron gun, the anti-reflection coating comprises depositing SiO₂ at an evaporation rate between 0.1 nm/s and 3.5 nm/s.

Clause 145. The method of any of Clauses 114 to 144, wherein depositing, with an electron gun, the anti-reflection coating comprises depositing SiO₂ at an evaporation rate between 0.29 nm/s and 3.1 nm/s.

Clause 146. The method of any of Clauses 114 to 145, wherein depositing, with an electron gun, the anti-reflection coating comprises depositing ZrO₂ at an evaporation rate of less than 3 nm/s nm/s.

Clause 147. The method of any of Clauses 114 to 146, wherein depositing, with an electron gun, the anti-reflection coating comprises depositing ZrO₂ at an evaporation rate between 0.09 nm/s and 2.1 nm/s.

Clause 148. The method of any of Clauses 114 to 147, wherein depositing, with an electron gun, the anti-reflection coating comprises depositing Al₂O₃ at an evaporation rate between 0.1 nm/s and 1.1 nm/s.

Clause 149. The method of any of Clauses 114 to 148, wherein depositing, with an electron gun, the anti-reflection coating comprises depositing Al₂O₃ at an evaporation rate between 0.09 nm/s and 0.51 nm/s.

Clause 150. The method of any of Clauses 114 to 149, wherein depositing, with an electron gun, the anti-reflection coating comprises depositing ITO at an evaporation rate between 0.05 nm/s and 0.5 nm/s.

Clause 151. The method of any of Clauses 114 to 150, wherein depositing, with an electron gun, the anti-reflection coating comprises depositing ITO at an evaporation rate between 0.09 nm/s and 0.21 nm/s.

Clause 152. The method of any of Clauses 114 to 151, wherein depositing, by thermal evaporation, the ultra-hydrophobic coating comprises depositing the ultra-hydrophobic coating with a thickness between 5 nm and 105 nm.

Clause 153. The method of any of Clauses 114 to 152, wherein depositing, by thermal evaporation, the ultra-hydrophobic coating comprises depositing the ultra-hydrophobic coating with a thickness between 9 nm and 101 nm.

Clause 154. The method of any of Clauses 114 to 153, wherein depositing, by thermal evaporation, the ultra-hydrophobic coating comprises depositing the ultra-hydrophobic coating at an evaporation rate between 0.05 nm/s and 1.0 nm/s.

Clause 155. The method of any of Clauses 114 to 154, wherein depositing, by thermal evaporation, the ultra-hydrophobic coating comprises depositing the ultra-hydrophobic coating at an evaporation rate between 0.09 nm/s and 0.51 nm/s.

Clause 156. The method of any of Clauses 114 to 155, wherein the vision optimization area increases the vision correction by an amount between −0.10 diopters and −0.90 diopters.

Clause 157. The method of any of Clauses 114 to 156, wherein the vision optimization area increases the vision correction by an amount between −0.24 diopters and −0.76 diopters.

Clause 158. An eyeglass lens that is resistant to condensation, wherein the lens is manufactured according to the method of any of Clauses 114 to 157.

### Further Considerations

In some embodiments, any of the clauses herein may depend from any one of the independent clauses or any one of the dependent clauses. In one aspect, any of the clauses (e.g., dependent or independent clauses) may be combined with any other one or more clauses (e.g., dependent or independent clauses). In one aspect, a claim may include some or all of the words (e.g., steps, operations, means or components) recited in a clause, a sentence, a phrase or a paragraph. In one aspect, a claim may include some or all of the words recited in one or more clauses, sentences, phrases or paragraphs. In one aspect, some of the words in each of the clauses, sentences, phrases or paragraphs may be removed. In one aspect, additional words or elements may be added to a clause, a sentence, a phrase or a paragraph. In one aspect, the subject technology may be implemented without utilizing some of the components, elements, functions or operations described herein. In one aspect, the subject technology may be implemented utilizing additional components, elements, functions or operations.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order and are not meant to be limited to the specific order or hierarchy presented.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

As used herein, the term “about” is relative to the actual value stated, as will be appreciated by those of skill in the art, and allows for approximations, inaccuracies and limits of measurement under the relevant circumstances. In one or more aspects, the terms “about,” “substantially,” and “approximately” may provide an industry-accepted tolerance for their corresponding terms and/or relativity between items, such as a tolerance of from less than one percent to 10 percent of the actual value stated, and other suitable tolerances.

As used herein, the term “comprising” indicates the presence of the specified integer(s), but allows for the possibility of other integers, unspecified. This term does not imply any particular proportion of the specified integers. Variations of the word “comprising,” such as “comprise” and “comprises,” have correspondingly similar meanings.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Although the detailed description contains many specifics, these should not be construed as limiting the scope of the subject technology but merely as illustrating different examples and aspects of the subject technology. It should be appreciated that the scope of the subject technology includes other embodiments not discussed in detail above.

Various other modifications, changes and variations may be made in the arrangement, operation and details of the method and apparatus of the subject technology disclosed herein without departing from the scope of the present disclosure. In addition, it is not necessary for a device or method to address every problem that is solvable (or possess every advantage that is achievable) by different embodiments of the disclosure in order to be encompassed within the scope of the disclosure. The use herein of “can” and derivatives thereof shall be understood in the sense of “possibly” or “optionally” as opposed to an affirmative capability.

What is claimed is:

1. An eyeglass lens that is resistant to condensation, the lens comprising (i) an anti-reflection coating having a layered structure having at least seven individual layers, wherein each layer of the layered structure comprises SiO₂, ZrO₂, ITO, or Al₂O₃, and (ii) an anti-fog layer disposed on the anti-reflection coating.

2. The eyeglass lens of claim 1, wherein:
the eyeglass lens comprises a resin lens, the resin lens comprising a first surface and a second surface opposite the first surface; and
a hardened layer disposed on each of the first surface and/or the second surface of the resin lens.

3. The eyeglass lens of claim 2, wherein the first and second surfaces of the resin lens are activated by ion bombardment.

4. The eyeglass lens of claim 2, wherein the hardened layer has a higher density than the resin lens.

5. The eyeglass lens of claim 2, wherein the layered structure is arranged with a first SiO₂ layer being nearest the resin lens and a third SiO₂ layer being farthest away from the resin lens.

6. The eyeglass lens of claim 1, wherein the layered structure of the anti-reflection coating comprises a first SiO₂ layer, a first ZrO₂ layer, a second SiO₂ layer, a second ZrO₂ layer, a first ITO layer, a first Al₂O₃ layer, and a third SiO₂ layer.

7. The eyeglass lens of claim 6, wherein:
the first SiO₂ layer has a thickness between 105 nm and 130 nm;
the first ZrO₂ layer has a thickness between 20 nm and 35 nm;
the second SiO₂ layer has a thickness between 15 nm and 25 nm;
the second ZrO₂ layer has a thickness between 40 nm and 55 nm;
the first ITO layer has a thickness between 1 nm and 15 nm;
the first Al₂O₃ layer has a thickness between 1 nm and 15 nm; and
the third SiO₂ layer has a thickness between 50 nm and 70 nm.

8. The eyeglass lens of claim 1, wherein, in order of layering, a first layer, a third layer, and a seventh layer each comprise SiO₂.

9. The eyeglass lens of claim 1, wherein, in order of layering, a second layer and a fourth layer each comprise ZrO₂.

10. The eyeglass lens of claim 1, wherein, in order of layering, a fifth layer comprises ITO.

11. The eyeglass lens of claim 1, wherein, in order of layering, a sixth layer comprises Al₂O₃.

12. The eyeglass lens of claim 1, wherein the anti-fog layer comprises a silicone polymer.

13. The eyeglass lens of claim 1, wherein the anti-fog layer comprises an organic silicone polymer film layer that is deposited on the anti-reflection coating by thermal evaporation.

14. An eyeglass lens that limits visual fatigue caused by blue light exposure, the eyeglass lens having an anti-reflection coating comprising a layered structure having at least seven individual layers, wherein each layer of the layered structure comprises SiO₂, ZrO₂, ITO, or Al₂O₃

15. The eyeglass lens of claim 14, wherein:
the eyeglass lens comprises a resin lens having a first surface and a second surface opposite the first surface; and
wherein the lens further comprises:
a hard coating disposed on the first surface and the second surface of the resin lens;
an ultra-hydrophobic coating disposed on each anti-reflection coating; and
a vision optimization area.

16. The eyeglass lens of claim 15, wherein the hard coating is dip coated on the first and second surfaces of the resin lens.

17. The eyeglass lens of claim 15, wherein the hard coating comprises a yellow light absorber.

18. The eyeglass lens of claim 15, wherein the resin lens comprises a blue light blocking resin lens.

19. The eyeglass lens of claim 15, wherein the resin lens comprises a blue light blocking resin lens with a refraction index between 1.20 and 2.00.

20. The eyeglass lens of claim 14, wherein:
a first SiO₂ layer has a thickness between 60 nm and 120 nm;
a first ZrO₂ layer has a thickness between 5 nm and 60 nm;
a second SiO₂ layer has a thickness between 20 nm and 100 nm;
a second ZrO₂ layer has a thickness between 20 nm and 150 nm;
a third SiO₂ layer has a thickness between 5 nm and 60 nm;
a third ZrO₂ layer has a thickness between 20 nm and 100 nm;
a first ITO layer has a thickness between 1 nm and 10 nm;
a first Al₂O₃ layer has a thickness between 1 nm and 12 nm; and
a fourth SiO₂ layer has a thickness between 50 nm and 100 nm.
